(19) United States
(12) Patent Application Publication
(10) Pub. No.: US 2002/0101743 A1
(43) Pub. Date: Aug. 1, 2002

(54) Power line separator

(75) Inventors: Ron Kallus, Haifa (IL); Prosper Dahan, Kiryat Bialik (IL)

Correspondence Address: FITCH EVEN TABIN AND FLANNERY, 120 SOUTH LA SALLE STREET, SUITE 1600, CHICAGO, IL, 60603-3406, US

(73) Assignee: Dip-Digital Power Ltd.

(21) Appl. No.: 09/859,054

(22) Filed: May 16, 2001

(30) Foreign Application Priority Data
Feb. 1, 2001 (IL) IL 141227

(51) Int. Cl. H02J 3/00

(52) U.S. Cl. 363/34

(57) ABSTRACT

A power line separator, comprising an input for connecting to a source of AC line voltage, an output for connecting to at least one user appliance intended for operation with a source of AC power having similar characteristics to the AC line voltage, and a front-end power factor correction unit coupled between the input and the output for producing from the AC line voltage a sinusoidal voltage that causes no distortion of the AC line voltage, while providing power to none-linear load, or loads with imaginary portion (reactive/inductive).

### FIELD OF THE INVENTION

This invention deals with the dual protection and Separation between user appliances and the Mains Utility power line.

### BACKGROUND OF THE INVENTION

The great variety of user appliances and their switch-mode power supplies, generate a wide spectrum of noise, which pollutes the Mains public network. On the other hand, the same polluted network affects the operational quality and the life cycle of the user equipment. One of the Mains polluting appliances is the Personal Computer, at least one of which can be found in almost every household. In addition, the low Power Factor of all the Hi-Fi equipment, along with the new trend of high-powered Home-Cinema devices dramatically reduce the quality of the Mains public network.

The low quality of the power line reduces the life cycle, and the sound quality of the household appliances.

Power Factor is defined as the ratio of real power to apparent power.

Power factor is related to the phase angle between voltage and current when there is a clear linear relationship. But it can still be defined when there is no apparent phase relationship between voltage and current, or when both voltage and current take on arbitrary values.

Power factor is a simple way to describe how much of the current contributes to real power in the load. A power factor of one indicates that 100% of the current is contributing to power in the load while a power factor of zero indicates that none of the current contributes to power in the load. Purely resistive loads such as heater elements have a power factor of unity. Pure capacitive or inductive loads have a power factor of zero and the current through them is defined in a more complex way.

The current in an AC line can be thought of as consisting of two components: real and imaginary. The real part results in power being absorbed by the load while the imaginary part results in power being reflected back into the source, such as is the case when current and voltage are of opposite polarity and their product, power, is negative. The reason it is important to have a power factor as close as possible to unity is that it is undesirable for any of the power to be reflected back to the source once power is delivered to the load. Current is needed to deliver power to the load and it will require still more current to carry it back to the source. Reflected power is undesirable for three reasons:

1. The transmission lines or power cord will generate heat according to the total current it carries, the real part plus the reflected part. This causes problems for the electric utilities and has prompted the passing of IEC 61000-3-2 and 61000-3-4, European regulations requiring all electrical equipment connected to a low voltage distribution system to minimize current harmonics and maximize power factor. In the USA, a similar standard is now being formalized by the IEEE Standards Committee, this draft has been assigned P1495/D1 for control purposes.

2. The reflected power that is not wasted in the resistance of the power cord may generate unnecessary heat in the source.

3. Since the AC mains (dock power) is limited to a finite current by their circuit breakers, it is desirable to get the most power possible from the given current available. This can happen only when the power factor is close to or equal to unity.

The new regulations and standards which came binding in Europe, as of January 2001, prohibit the sale and use of electric equipment whose Power Factor is less than 0.9, and will put many existing devices out of operation.

### SUMMARY OF THE INVENTION

It is therefore an object of the invention to provide a unit which may be plugged into the Mains Supply and to which one or more user appliances may be connected, presenting substantially unity Power Factor to the Power network, while providing a pure, stable sinusoidal voltage to the, user appliances. On the other hand, the user appliances can continue to operate with low Power Factor, generating Harmonics over a wide spectrum, all of which are suppressed by the unit and prevented from entering the Mains.

In accordance with the invention, there is provided a power line separator, comprising:

an input for connecting to a source of AC line voltage,

an output for connecting to at least one user appliance intended for operation with a source of AC power having similar characteristics to the AC line voltage, and

a front-end power factor correction unit coupled between the input and the output for producing from the AC line voltage a clean sinusoidal voltage that may be used to feed any type of user appliance and causes no distortion of the source of the AC power.

According to a preferred embodiment of the invention, the front-end power factor correction unit comprises:

an input for connecting to a source of AC mains voltage,

a rectifier coupled to the input for rectifying an AC voltage connected thereto and producing a full-wave rectified DC voltage,

a CPU to sense the full-wave rectified DC voltage,

a power factor correction (PFC) circuit coupled to the rectifier and operating without any energy storage for producing a power factor-corrected voltage,

a holdover capacitor coupled to an output of the power factor correction circuit for receiving the power factor-corrected voltage, and

a power bridge coupled to the CPU and controlled thereby for producing positive and negative voltage levels of the AC voltage output.

The power line separator according to the invention functions as a front-end unit that derives AC power from the mains supply at nearly unity power factor and feeds AC power to one or more user appliances with non linear load. Such a unit improves the present situation in four ways:

1. Prevents the existing equipment from corrupting the Mains Utility power lines, thus saving the utility company a lot of energy.

2. Prevents transformers and transmission lines from overheating.

3. Provides the user equipment with a pure sinusoidal alternating voltage, which is stable and free of any distortion.

4. Protects the equipment from all line modulations and other line related noise from communication or control signals.

In accordance with the invention, these requirements are achieved at an affordable price. According to a preferred embodiment, the PFC operates in current critical mode with no storage and low EMI, while the control is based on average current feed forward mode, which prevents any potential oscillations of the output.

In accordance with the invention, power factor can be improved with the use of either a passive or an active input circuit. Passive circuits usually contain a combination of large capacitors, inductors, and rectifiers that operate at the ac line frequency. Active circuits incorporate some form of a high frequency switching converter for power processing, with the boost converter being the most popular topology. Since active input circuits operate at a frequency much higher than that of the AC line, they are smaller, lighter in weight, and more efficient than passive circuits that yield similar results. With proper control of the pre-converter, almost any complex load can be made to appear resistive to the AC line, thus significantly reducing the harmonic current content.

Two main reasons led to this circuit topology:

1. Reduced components' stress, the transistors have to work under half of the provided output voltage.

2. High efficiency achieved by feeding the leakage inductance back to the holding capacitor.

A preferred embodiment makes use of the MC34262 high performance, critical conduction, current-mode power factor controller manufactured by Motorola, Inc. specifically designed for use in off-line active pre-converters. This device provides the necessary features required to significantly enhance poor power factor loads by keeping the ac line current sinusoidal and in phase with the line voltage. The device is augmented with external circuitry to allow for a high power application.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram showing schematically a power line separator connecting one or more electrical appliances to an AC power source;

FIG. 2 is a block diagram showing functionally the power line separator according to the invention;

FIG. 3 shows schematically a PFC sub-unit used within the power line separator shown in FIG. 2;

FIGS. 4a and 4b show pictorially voltage waveforms of the Input and output voltages of the PFC sub-unit;

FIG. 5 shows schematically a DC to AC converter used in the power line separator of FIG. 2; and

FIGS. 6a and 6b are voltage and current waveforms showing graphically the Mains input source of the AC power and the corresponding output, source to the user appliance.

### DETAILED DESCRIPTION OF A SPECIFIC EMBODIMENT

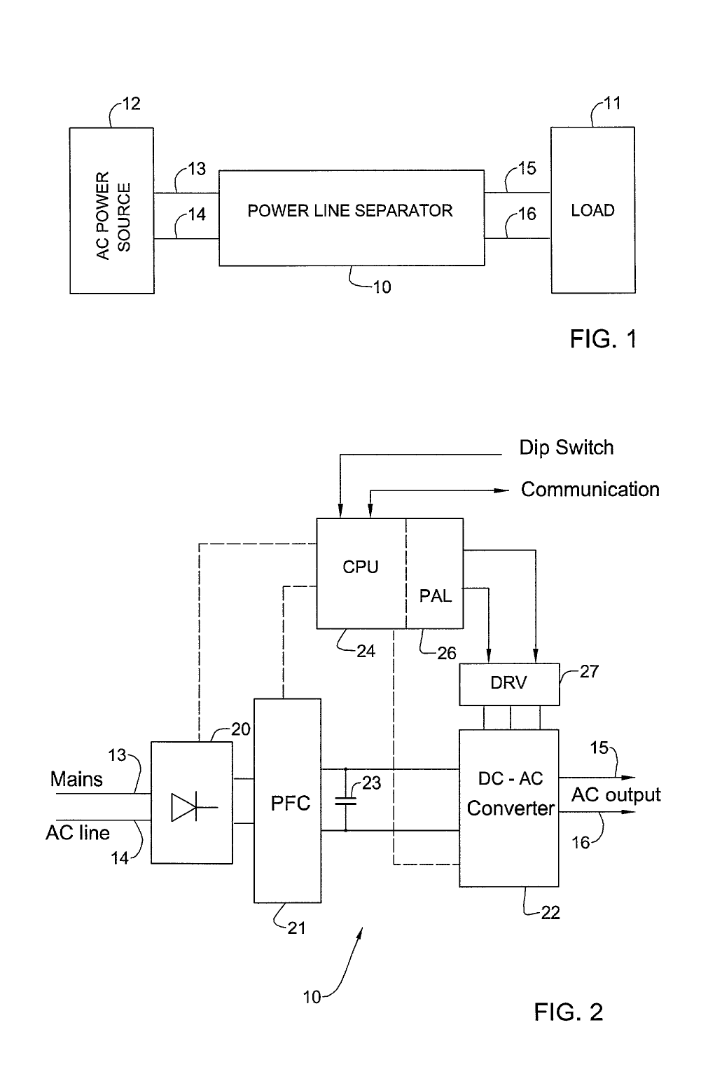

FIG. 1 shows schematically a power line separator 10 for connecting one or more electrical appliances 11 to an AC power source 12. The power line separator 10 has a pair of input terminals 13, 14 for connecting to the AC power source 12 and a pair of output terminals 15, 16 for coupling the appliances 11 thereto.

As shown in FIG. 2, the input terminals 13 and 14 are coupled via a rectifier 20 to a Power Factor Correction (PFC) circuit 21, which feeds a DC-AC converter 22. The DC-AC converter 22 generates a clean and stable AC voltage output. A holdover capacitor 23 is connected across the output of the PFC circuit 21 and remains in a charged state for so long as the DC voltage level, at the output of the PFC circuit 21, is higher than its own. The Power Line Separator 10 is controlled by a CPU 24 that receives respective signals from the rectifier 20, the PFC circuit 21 and the DC-AC converter 22, and uses floating drivers to control the DC-AC converter 22. Coupled to the CPU 24 is a programmable array logic element (PAL) 26, which provides signals to synchronize the driver circuitry 27 shown schematically as DRV for controlling the DC-AC converter 22.

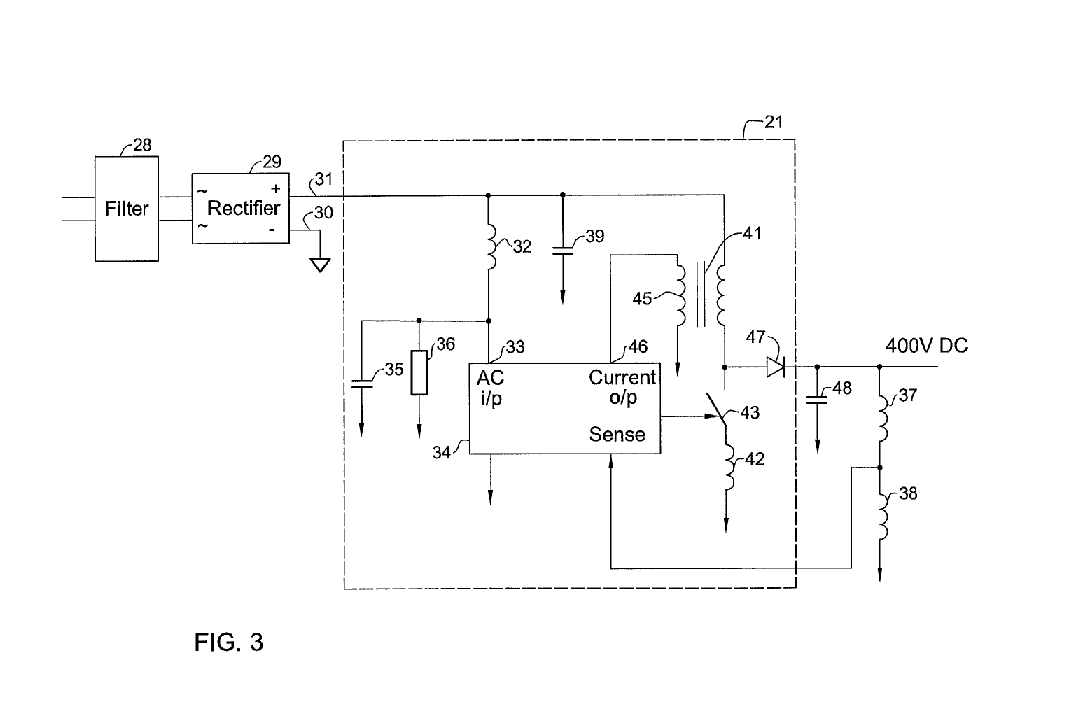

FIG. 3 shows in greater detail the PFC circuit 21, which includes a filter 28 for: common mode rejection, EMI/RFI supression and over-voltage protection, whose output is coupled to a bridge rectifier 29 having a DC negative output 30 connected to ground, GND. A DC positive output 31 of the bridge rectifier 29 is connected via a resistor 32 to the AC input 33 of the power factor controller 34 manufactured by Motorola, Inc. Also connected between the AC input 33 and GND is an RC network comprising a capacitor 35 and a resistor 36. A voltage divider comprising a pair of resistors 37 and 38 is connected in series between the full wave rectified 400V signal and GND. The voltage on the junction between the two resistors 37 and 38 is fed-back to the power factor controller 34. The resistors 37 and 38 operate as a voltage divider for feeding back a fraction of the full wave rectified 400V signal to be sensed by the PFC controller 34. In order that the PFC controller 34 can determine when the fed-back voltage reaches its instantaneous peak value, it includes a multiplier (not shown) that multiplies the fed-back voltage by the fraction of the output voltage sensed by the voltage divider i.e. R₃₇/(R₃₇+R₃₈) where R₃₇ denotes the resistance of the resistor 37 and R₃₈ denotes the resistance of the resistor 38.

Connected to the DC positive output 31 is a first end of a high frequency capacitor 39 and a first end of a choke 41, whose second end is connected via a resistor 42 to GND by a switch 43, controlled via an output 44 of the power factor controller 34. A first end of a secondary winding 45 of the chock 41 is connected to a current sensing input 46 of the power factor controller 34 and its second end is grounded. The second end of the high frequency capacitor 39 is grounded as well. The anode of a catch diode 47 is connected to the current choke 41 at its junction with the switch 43, while its cathode is connected to a holdover capacitor 48, which is held at 400 volts (peak).

The PFC operates in a discontinuous mode, the controller opening the switch 43 at zero crossing, and allowing the current to build-up to the point where it reaches its peak value, based on the fractional voltage fed back by the voltage divider. At this instant, the switch 43 is closed and the voltage drops to a lower point than the holdover capacitor 48. The catch diode 47 prevents current flow in the reverse direction while its voltage falls below the voltage level across the holdover capacitor 48. The voltage continues to fall, until it crosses zero, when the switch 43 is again opened. The PFC feeds the holding capacitor 48 by drawing current from the source of AC line voltage throughout the complete AC cycle. Consequently, switching “noise” and harmonics reflected from the user appliance are blocked and have no effect on the noise and harmonics which are fed back by the power line separator into the source of AC line voltage. Moreover, intermittent interruptions in the AC line voltage causes no degradation of the AC output to the user appliance, since the holding capacitor 48 continues to supply energy during voltage interruptions for up to 40 ms. This means, in practice, that the holdover capacitor 48 can supply voltage for up to two AC cycles, assuming a 50 Hz supply.

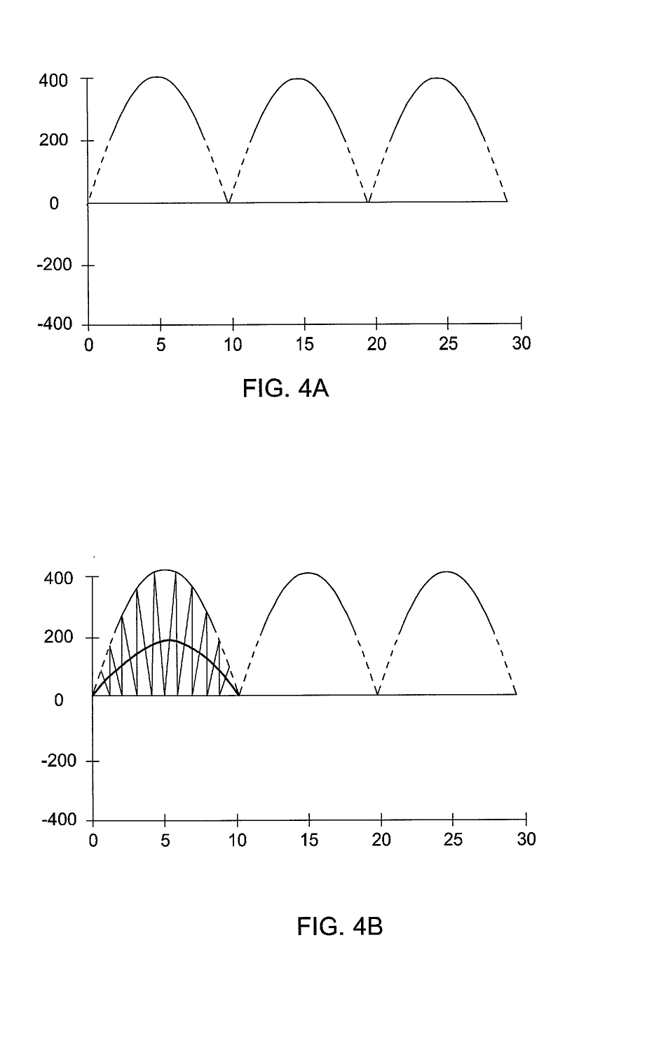

FIG. 4a shows the sinusoidal waveform corresponding to the full-wave rectified DC voltage appearing on the positive output 31 of the rectifier 29.

FIG. 4b shows the voltage generated by the PFC controller 34 appearing across the holding capacitor 48, and across the voltage divider constituted by resistors 37 and 38. This voltage is generated by a saw-tooth waveform that climbs from zero until it reaches the instantaneous peak of the full wave rectified 400V, when it falls to zero and climbs again to the instantaneous peak of the full wave rectified 400V and so on, such that the full wave rectified 400V is shown as the envelope of the saw-tooth waveform. The actual voltage thus output by the PFC controller 21 is the average of the saw-tooth waveform, this being shown pictorially in heavy line.

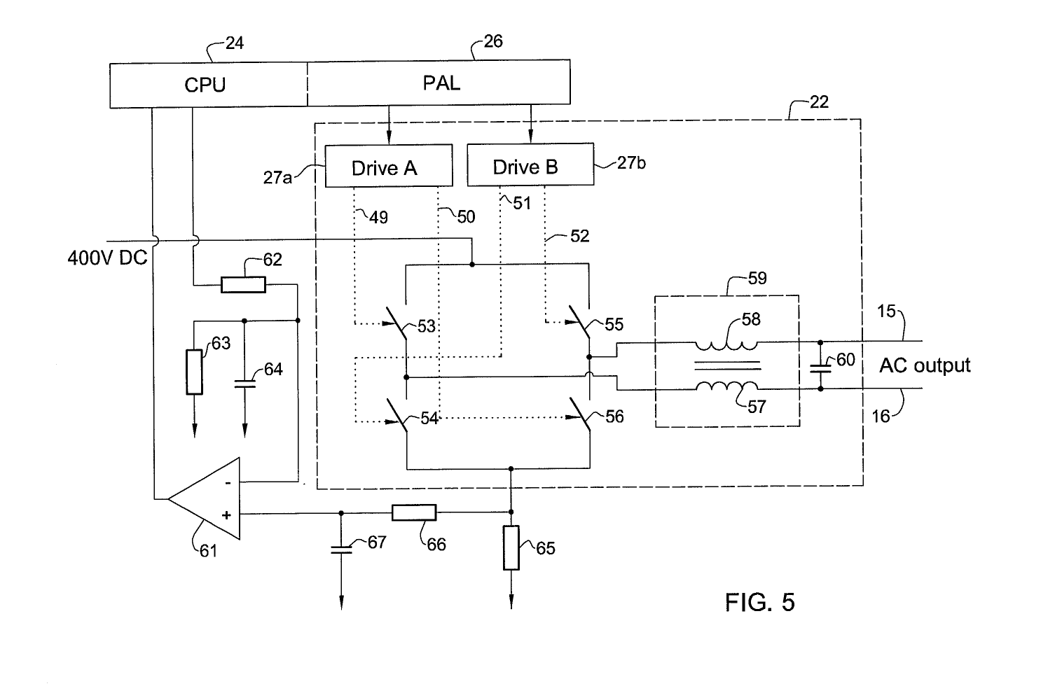

FIG. 5 shows in greater detail the DC-AC converter 22 and associated control circuitry based on a power bridge comprising four switches 53, 54, 55 and 56. Thus, the CPU 24 senses and limits the current flow from the power bridge to ground, using a comparator 61 that receives from the CPU 24 a reference signal whose amplitude is determined by a voltage divider comprising a pair of resistors 62 and 63, and which is filtered by a capacitor 64, and fed to the negative input of the comparator 61. The positive input of the comparator 61 is connected via a resistor 66 to the low voltage rail of the power bridge, and resistor 65, filtered by capacitor 67.

The CPU 24, which operates in conjunction with the PAL 26, controls the driver 27. In fact, the driver 27 has two output sections 27a and 27b, as will now be explained. The two output sections operate in harmony to control the four switches 53, 54, 55, 56 of the power bridge, such that at the same time that one output section closes one pair of switches, the second output section opens the other pair of switches, and vice versa. The first driver section 27a has a pair of outputs 49 and 50 that control corresponding switches 53 and 56, respectively. The second output section 27b of the PAL driver has a pair of outputs 51, 52 that control the second pair of switches 54 and 55 respectively. Together, the two pairs of switches are opened and closed in antiphase for connecting the full-wave rectified DC voltage and GND, respectively, to opposing ends of a transformer 59 having a pair of windings 57 and 58 across which is connected an output capacitor 60. Specifically, when the switches 53 and 56 are open, and switches 54 and 55 are closed, the winding 58 is connected to the full-wave rectified DC voltage, while winding 57 is connected to GND. In this case, energy is transferred onward to the output such that its positive polarity is on the winding 58 and the negative polarity is on winding 57. On the other hand, when the switches 53 and 56 are closed, and switches 54 and 55 are open, the winding 57 is connected to the 400 volt DC supply, while winding 58 is connected to GND. In this case, energy is transferred onward to the output such as its positive polarity is on the winding 57 and the negative polarity is on winding 58. The rate at which the PAL interchanges between the two opposing states, corresponds to the frequency of the input Mains supply, which is present across the output capacitor 60.

The sine wave is built by a PWM switching technique, driven by and synchronized to the Mains input source, by the CPU 24 through the PAL 26. In a preferred embodiment, the switches 53, 54, 55 and 56 are high power MOSFETs having a peak current rating of 100 ampère. However, if desired, the peak current rating can be further increased by utilizing MOSFETs of appropriate rating.

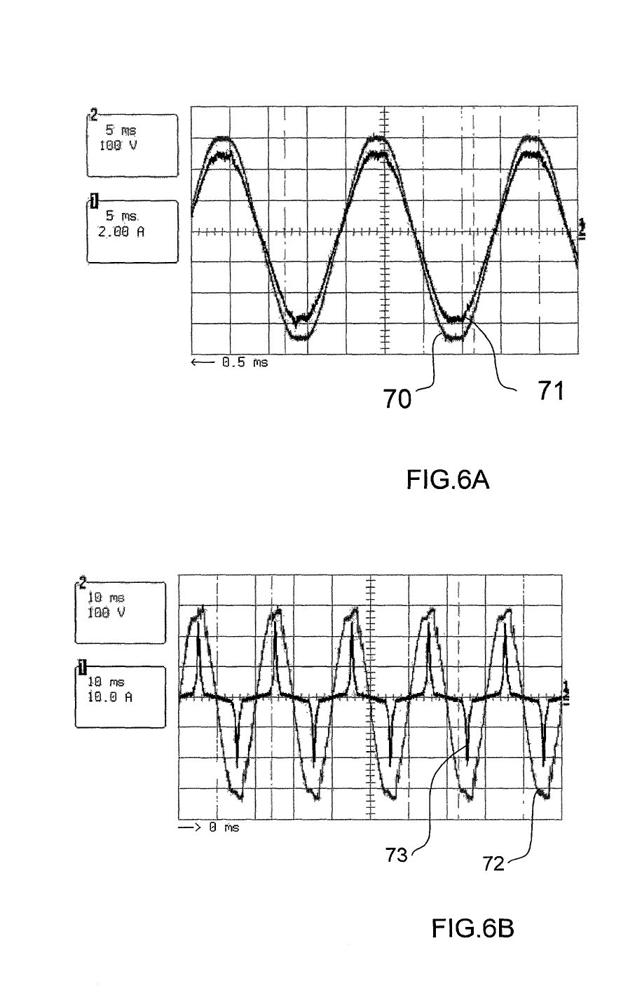

FIG. 6a shows graphically a waveform of the input voltage 70 and current 71, respectively while FIG. 6b shows graphically waveforms of the output voltage and current, 72 and 73, respectively. It will be seen from FIG. 6a that the input voltage and current waveforms 70 and 71 are exactly in phase without harmonics. Likewise, it is clear from FIG. 6b that the output voltage and current waveforms 72 and 73 are in phase, but the load (i.e. at least one user appliance) draws non-linear current with a crest-factor of higher than 1:6)and low Power Factor. Moreover, switching “noise” and harmonics reflected from the load, are blocked and have no effect on the noise and harmonics, which are fed back by the power line separator into the source of AC line voltage. It should also be noted that an intermittent absence of up to two cycles in the AC line voltage causes no degradation of the AC output to the user appliance.

1. A power line separator, comprising:
an input for connecting to a source of AC line voltage,
an output for connecting to at least one user appliance intended for operation with a source of AC power having similar characteristics to the AC line voltage, and
a front-end power factor correction unit coupled between the input and the output for producing from the AC line voltage a clean sinusoidal voltage that may be used to feed any type of user appliance and causes no distortion of the source of the AC power.

2. The power line separator according to claim 1, wherein the front-end power factor correction unit maintains current and voltage drawn from the source of AC line voltage substantially in phase regardless of any phase shift between current and voltage caused by at least one user appliance.

3. The power line separator according to claim 2, wherein the at least one user appliance draws non-linear current with high crest-factor having high current peaks.

4. The power line separator according to claim 3, wherein said current peaks have an order of magnitude of 100 ampère.

5. The power line separator according to claim 2, wherein switching “noise” and harmonics reflected from the at least one user appliance, are blocked and have no effect on the noise and harmonics which are fed back by the power line separator into the source of AC line voltage.

6. The power line separator according to claim 3, wherein switching “noise” and harmonics reflected from the at least one user appliance, are blocked and have no effect on the noise and harmonics which are fed back by the power line separator into the source of AC line voltage.

7. The power line separator according to claim 3, wherein an intermittent absence of up to two cycles in the AC line voltage causes no degradation of the AC output to the at least one user appliance.

8. A front-end power factor correction unit, comprising:
an input for connecting to a source of AC mains voltage,
a rectifier coupled to the input for rectifying an AC voltage connected thereto and producing a full-wave rectified DC voltage,
a CPU to sense the full-wave rectified DC voltage,
a power factor correction (PFC) circuit coupled to the rectifier and operating without any energy storage for producing a power factor-corrected voltage,
a holdover capacitor coupled to an output of the power factor correction circuit for receiving the power factor-corrected voltage, and
a power bridge coupled to the CPU and controlled thereby for producing positive and negative voltage levels of the AC voltage output.

9. The front-end power factor correction unit according to claim 8, wherein the power factor correction circuit is configured to operate in a Current Critical Mode to provide energy to a holdover capacitor during a majority of the mains power cycle, allowing for low amplitude sinusoidal current to trickle charge the holding capacitor, while presenting a pure resistive load to said source of AC mains voltage.

10. The front-end power factor correction unit according to claim 9, wherein the power factor correction circuit is responsive to the instantaneous amplitude of the full-wave rectified DC voltage for determining when the full-wave rectified DC voltage reaches an instantaneous peak value, and disconnects current to the holding capacitor when the half-wave rectified DC voltage reaches said instantaneous peak value.

11. The front-end power factor correction unit according to claim 8, further including a current sense circuit to protect its AC output against a short.

12. The front-end power factor correction unit according to claim 8, including:
a comparator having a negative input coupled to the CPU for receiving therefrom a reference signal, an output for feeding an output signal to the CPU, and having a positive input connected to a low voltage rail of the power bridge.

13. The front-end power factor correction unit according to claim 12, wherein:
the CPU operates in conjunction with a PAL driver for controlling the PAL driver.

14. The front-end power factor correction unit according to claim 13, wherein:
the PAL driver has two output sections operating in harmony to control the power bridge.

15. The front-end power factor correction unit according to claim 14, wherein:
the power bridge comprises four switches, opposing pairs of which are controlled by respective output sections of the PAL driver such that at the same time that a first output section closes a first pair of switches, a second output section opens a second pair of switches, and vice versa.

16. The front-end power factor correction unit according to claim 15, wherein:
the first output section of the PAL driver has a pair of outputs that control the first pair of switches respectively, and the second output section of the PAL driver has a pair of outputs that control the second pair of switches respectively, for connecting the full-wave rectified DC voltage and GND, respectively, to opposing ends of a transformer having first and second windings such that when the first pair of switches are open, and the second pair of switches are closed, the winding is connected to the full-wave rectified DC voltage, while winding is connected to GND, and when the first pair of switches are closed, and the second pair of switches are open, the winding is connected to the full-wave rectified DC voltage, while winding is connected to GND;
the rate at which the PAL interchanges between the two opposing states, is synchronized with the frequency of the source of the input AC voltage present across an output capacitor connected across the two windings of the transformer.
